(19) United States
(12) Patent Application Publication
(10) Pub. No.: US 2026/0126338 A1
(43) Pub. Date: May 7, 2026

(54) Seal Inspection Device and Seal Inspection Method for Battery Cell

(71) Applicant: SK On Co., Ltd., Seoul (KR)

(72) Inventor: Da Eun KIM, Daejeon (KR)

(21) Appl. No.: 19/379,988

(22) Filed: Nov. 5, 2025

(30) Foreign Application Priority Data
Nov. 7, 2024 (KR) 10-2024-0156985

(51) Int. Cl. G01M 3/26; H01M 10/42

(52) U.S. Cl. CPC G01M 3/26; H01M 10/4228; H01M 10/4285

(57) ABSTRACT

A seal inspection device for a battery cell includes a chamber in which a battery cell is disposed, a hopper disposed to be in close contact with the battery cell, a decompression unit structured to depressurize an interior of the chamber, a gas injection unit structured to inject gas into the chamber or an interior of the battery cell, a sealing member installation unit structured to install a sealing member in an inlet of the battery cell to seal the inlet, and a determination unit structured to determine whether the battery cell is sealed.

### CROSS-REFERENCE TO RELATED APPLICATIONS

This patent document claims the priority and benefits of Korean Patent Application No. 10-2024-0156985 filed on November 07, 2024, the disclosure of which is incorporated herein by reference in its entirety.

### TECHNICAL FIELD

The disclosure and implementations disclosed in this patent document generally relate to a seal inspection device and a seal inspection method for a battery cell.

### BACKGROUND

Unlike primary batteries, secondary batteries may be charged and discharged, and thus may be applied to a wide range of applications, including digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. Multiple battery cells may be formed into a stacked cell assembly.

The cell assembly may be disposed within a module housing to form a battery module, and multiple battery modules may be disposed within a pack frame to form a battery pack.

### SUMMARY

Seal inspection of the related art battery cells include injecting inert gas into the battery cell and sealing the inlet, of which both processes are performed in separate devices. This results in the inert gas leaking out of the battery cell during the process, reducing inspection accuracy.

The present disclosure can be implemented in some embodiments to provide a seal inspection device and a seal inspection method for a battery cell, in which seal inspection equipment and processes for battery cells may be simplified.

According to an aspect of the present disclosure, the accuracy of battery cell sealing inspection may be improved.

A seal inspection device and seal inspection method for a battery cell according to an aspect of the present disclosure may be widely applied to devices within green technology fields such as electric vehicles, battery charging stations, and other battery-powered solar and wind power generation. Furthermore, the seal inspection device and seal inspection method in the present disclosure may be used in eco-friendly electric vehicles, hybrid vehicles, and other vehicles that aim to ameliorate the effects of climate change by suppressing air pollution and greenhouse gas emissions.

In some embodiments of the present disclosure, a seal inspection device for a battery cell includes a chamber in which a battery cell is disposed; a hopper disposed to be in close contact with the battery cell; a decompression unit structured to depressurize an interior of the chamber; a gas injection unit structured to inject gas into the chamber or an interior of the battery cell; a sealing member installation unit structured to install a sealing member in an inlet of the battery cell to seal the inlet; and a determination unit structured to determine whether the battery cell is sealed.

In an embodiment, the determination unit may include a gas detection unit detecting gas within the chamber.

In an embodiment, the determination unit may further include a diagnostic unit structured to diagnose whether the chamber is sealed, based on an amount of detected gas.

In an embodiment, the determination unit may include a pressure sensor disposed within the chamber and measuring pressure within the chamber; and a diagnostic unit structured to diagnose whether the chamber is sealed, based on the measured pressure.

In an embodiment, the gas may include an inert gas.

In an embodiment, the inert gas may include helium.

In an embodiment, the sealing member may include a ball, and the sealing member installation unit may include an adjustment unit disposed such that the sealing member is able to be installed one by one in the inlet.

In an embodiment, the adjustment unit may include an opening/closing unit disposed such that the sealing member is able to be installed one by one, and an adjustment space in which the opening/closing unit is disposed.

In some embodiments of the present disclosure, a method of inspecting sealing of a battery cell includes disposing a battery cell within a chamber; depressurizing an interior of the chamber; injecting gas into the battery cell disposed within the chamber; sealing an inlet of the battery cell, after the injecting; and diagnosing whether the gas injected into the battery cell has leaked outside of the battery cell.

In an embodiment, in the diagnosing, diagnosing may be performed based on an internal gas pressure of the chamber.

In an embodiment, the diagnosing may be performed after a preset time has elapsed in the sealing.

In an embodiment, the gas may include helium.

In some embodiments of the present disclosure, a method of inspecting sealing of a battery cell includes disposing a battery cell within a chamber; depressurizing an interior of the chamber; injecting gas into the chamber; and diagnosing whether the gas injected into the chamber is introduced into the battery cell, after the injecting.

In an embodiment, in the diagnosing, diagnosing may be performed based on an internal gas pressure of the chamber.

In an embodiment, the diagnosing may be performed after a preset time has elapsed in the injecting.

In an embodiment, the gas may include helium.

### BRIEF DESCRIPTION OF DRAWINGS

Certain aspects, features, and advantages of the present disclosure are illustrated by the following detailed description with reference to the accompanying drawings.

FIG. 1 is a perspective view illustrating an example of a battery cell subject to a seal inspection.

FIG. 2 is a flowchart illustrating a method of inspecting the sealing of a battery cell according to an embodiment.

FIGS. 3A, 3B, 3C and 3D are cross-sectional views sequentially illustrating the operation of a seal inspection device for a battery cell, which inspects whether a battery cell is sealed according to an embodiment.

FIGS. 4A, 4B and 4C are cross-sectional views sequentially illustrating the operation of a sealing member installation unit of a seal inspection device for a battery cell according to an embodiment.

FIG. 5 is a flowchart illustrating a method of inspecting the sealing of a battery cell according to another embodiment, in which whether a battery cell is sealed.

FIGS. 6A, 6B and 6C are cross-sectional views sequentially illustrating the operation of a seal inspection device for a battery cell according to another embodiment, in which whether a battery cell is sealed.

### DETAILED DESCRIPTION

Features of the present disclosure disclosed in this patent document are described by example embodiments with reference to the accompanying drawings.

The same reference numbers or symbols in respective drawings attached to this specification indicate parts or components that perform substantially the same functions. For convenience of explanation and understanding, the same reference numbers or symbols may be used in different embodiments. In detail, even if components with the same reference numbers are depicted in multiple drawings, the multiple drawings do not all represent one embodiment.

In the following description, the singular expression includes plural expressions unless the context clearly indicates otherwise. Terms such as “include”, “comprise”, “configure,” etc. indicate the presence of features, numbers, operations, operations, components, parts, or combinations thereof described in the specification, but should be understood as not excluding the possibility of the presence or addition of one or more other features, numbers, operations, operations, components, parts, or combinations thereof.

Furthermore, in the following description, terms such as “top,” “upper,” “on,” “lower,” “bottom,” “below,” “side,” “front,” “back,” “rear,” etc. are expressed based on the directions depicted in the drawings, and it should be noted in advance that the expressions may vary depending on the orientation of the object.

Additionally, terms including ordinal numbers, such as “first,” “second,” etc., may be used in this specification and claims to distinguish between components. These ordinal numbers are used to distinguish identical or similar components from each other, and the use of these ordinal numbers should not be interpreted as limiting the meaning of the terms. For example, the order of use or disposition of components associated with these ordinal numbers should not be construed as being limited by their numbers. If necessary, respective ordinal numbers may be used interchangeably.

Hereinafter, the present disclosure will be described in detail with reference to the accompanying drawings. However, these are merely illustrative, and the present disclosure is not limited to the detailed embodiments illustrated by the illustrative examples.

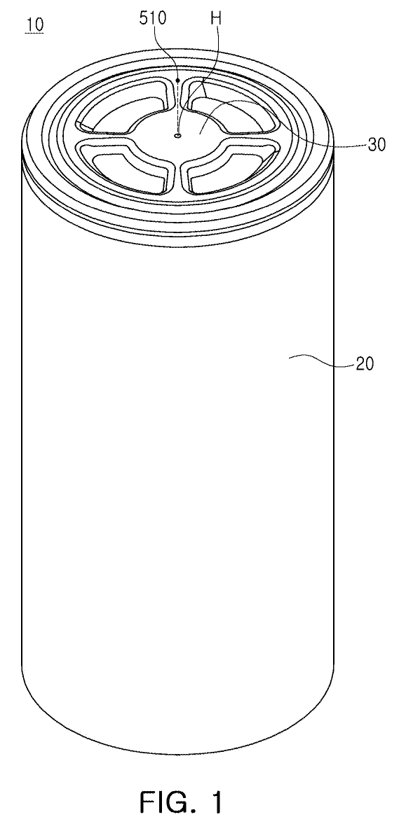

FIG. 1 is a perspective view illustrating an example of a battery cell 10 subject to a sealing inspection.

Referring to FIG. 1, the battery cell 10 subject to a sealing inspection according to an embodiment may be a cylindrical battery cell 10, but is not limited thereto. The cylindrical battery cell 10 will be described below as an example.

A battery cell 10 according to an embodiment may include a cell case 20 including an internal accommodating space, an electrode assembly disposed within the accommodating space of the cell case 20, and a cap assembly 30 sealing one side of the cell case 20.

The electrode assembly may include a cathode plate, an anode plate, and a separator. The separator may be composed of an insulator interposed between the anode plate and the cathode plate. The electrode assembly may be configured in a stack type in which the cathode plate, the anode plate, and the separator are alternately stacked. Alternatively, the electrode assembly may be configured as a jelly roll type, in which a cathode plate, an anode plate, and a separator interposed between the cathode plates are alternately stacked and wound into a roll.

The cathode plate and anode plate may each have a structure in which a cathode active material or an anode active material is coated on a foil. For example, the anode plate may be formed by coating graphite or other materials on a copper or nickel foil, and the cathode plate may be formed by coating a transition metal oxide active material on an aluminum foil.

The cell case 20 may accommodate the electrode assembly. In detail, the electrode assembly may be accommodated in the cell case 20.

The cell case 20 may have a cylindrical shape with one open end. The cell case 20 may have a hollow cylindrical shape with a circular cross-section. The electrode assembly may be disposed in the accommodation space within the cell case 20 through an open side of the cell case 20.

The cap assembly 30 may seal the opening of the cell case 20. The cap assembly 30 may be joined to the side wall of the cell case 20 by crimping, welding, or the like.

The cap assembly 30 may be provided with an inlet (H) for injecting electrolyte into the cell case 20. The inlet (H) may be formed at the center of the cap assembly 30, but the location and size thereof may vary. The inlet (H) may be sealed with a sealing member 510 after the electrolyte is injected.

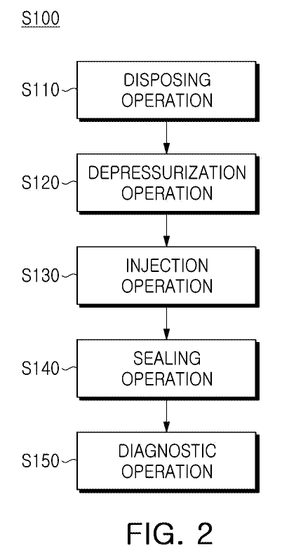

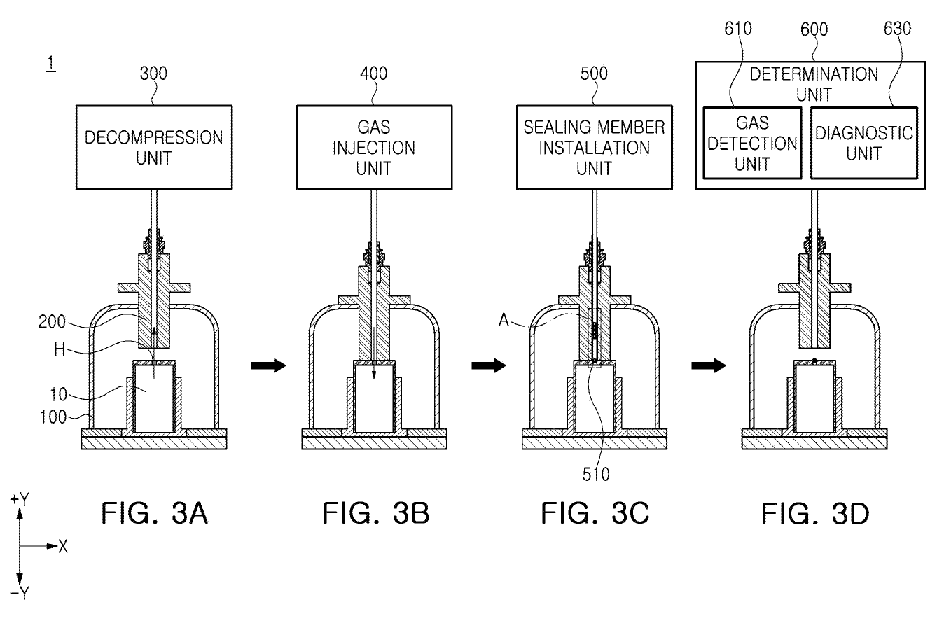

FIG. 2 is a flowchart illustrating a method of inspecting the sealing of a battery cell (S100) according to an embodiment. FIGS. 3A, 3B, 3C and 3D are cross-sectional views sequentially illustrating the operation of a seal inspection device 1 for a battery cell, which inspects whether a battery cell 10 is sealed according to an embodiment.

Referring to FIGS. 2, 3A, 3B, 3C and 3D, a seal inspection device 1 for a battery cell according to an embodiment may include a chamber 100 in which a battery cell 10 is disposed, a hopper 200 disposed to be in close contact with the battery cell 10, a decompression unit 300 that depressurizes the interior of the chamber 100, a gas injection unit 400 that injects gas into the chamber 100 or the interior of the battery cell 10, a sealing member installation unit 500 that installs a sealing member 510 into the inlet (H) of the battery cell 10 to seal the inlet (H), and a determination unit 600 that determines whether the battery cell 10 is sealed.

In the case of the hopper 200, at least some of the decompression unit 300, gas injection unit 400, sealing member installation unit 500, or determination unit 600 may be integrally formed, connected, or coupled.

A method of inspecting sealing of a battery cell (S100) according to an embodiment may include a disposing operation (S110) of disposing the battery cell 10 within a chamber 100.

At this time, the battery cell 10 may have an electrolyte injected therein, but the inlet (H) may be in the state in which it is not sealed.

The battery cell 10 may be disposed on a tray within the chamber 100. This allows the battery cell 10 to be secured and subsequently aligned with the gas injection unit 400 and sealing member installation unit 500.

A method of inspecting sealing of a battery cell (S100) according to an embodiment may include a depressurization operation (S120) of depressurizing the inside of a chamber 100.

Depressurization within the chamber 100 may be performed by a decompression unit 300. For example, the decompression unit 300 may be a vacuum pump. However, the decompression unit 300 is not limited to a vacuum pump. Any device capable of reducing the pressure within the chamber 100 may be included in the decompression unit 300 of the present disclosure.

If the pressure within the chamber 100 decreases, the pressure within the battery cell 10 disposed within the chamber 100 may also decrease. In detail, if the gas within the chamber 100 is discharged to the outside of the chamber 100 by the decompression member, thereby reducing the pressure within the chamber 100, the gas present within the battery cell 10 may be discharged to the outside of the battery cell 10, for example, into the chamber 100. The gas discharged into the chamber 100 may then be discharged outside the chamber 100 by the decompression unit 300. Therefore, after a certain period of time has elapsed after the decompression unit 300 is activated, the gas inside the chamber 100 and the battery cell 10 may be discharged outside the chamber 100.

A method of inspecting sealing of a battery cell (S100) according to an embodiment may include an injection operation (S130) of injecting gas into the battery cell 10 disposed within the chamber 100. The gas injected into the chamber 100 may include an inert gas. The inert gas may include helium, which diffuses easily, which may improve the accuracy and speed of the inspection.

The gas injection may be performed by a gas injection unit 400. The gas injection unit 400 may include a gas injection pipe connected to an inlet (H). The gas injection unit 400 may inject gas into the battery cell 10 through the inlet (H). For example, the inlet (H) may be a passage through which electrolyte is injected and a passage through which gas is injected.

The gas may include an inert gas with low reactivity to prevent the gas from reacting with electrolytes or the like within the battery cell 10. Since smooth gas diffusion is required for accurate sealing inspection, the gas may include helium, the lightest of the inert gases.

The hopper 200 may be in close contact with the battery cell 10 to prevent gas from leaking outside the battery cell 10 during the gas injection process. The hopper 200 may move in the direction (-Y) toward the battery cell 10 to ensure close contact with the battery cell 10 during the gas injection process.

For example, when the hopper 200 moves in the direction (-Y) of the battery cell 10 and comes into close contact with the battery cell 10, the gas injection tube is inserted into the hopper 200 and connected to the inlet (H), allowing gas to be injected into the battery cell 10.

According to an embodiment, a method of inspecting sealing of a battery cell (S100) is performed after the injection operation (S130) and may include a sealing operation (S140) of sealing the inlet (H) of the battery cell 10.

Sealing of the inlet (H) of the battery cell 10 may be performed by a sealing member installation unit 500. As an example, the sealing member 510 may include a ball. However, the sealing member 510 is sufficient as long as it may seal the inlet (H), and the shape thereof is not limited. For convenience of explanation, the shape of the sealing member 510 is described below as a spherical ball.

After the injection operation (S130), the gas injection tube is removed from the inside of the hopper 200, and the sealing member installation unit 500 may be inserted into the hopper 200. Thereafter, a ball inside the sealing member installation unit 500 may be installed in the inlet (H) to seal the inlet (H).

A method of inspecting sealing of a battery cell (S100) according to an embodiment may include a diagnostic operation (S150) of diagnosing whether gas injected into the battery cell 10 has leaked to the outside of the battery cell 10. The diagnostic operation (S150) may diagnose whether the battery cell 10 is sealed based on the pressure of the gas inside the chamber 100.

Whether gas has leaked to the outside of the battery cell 10 may be determined by a determination unit 600, and the determination unit 600 may include a gas detection unit 610 for detecting gas inside the chamber 100. The gas detection unit 610 may detect whether a specific gas exists inside the chamber 100 based on the pressure of the specific gas injected into the battery cell 10.

For example, if a specific gas is injected into the battery cell 10 and the sealing member 510 is installed in the inlet (H), and the battery cell 10 is not properly sealed, the specific gas may leak out of the battery cell 10. This causes the specific gas to exist within the chamber 100, and the pressure of the specific gas may be measured by the gas detection unit 610. If the gas detection unit 610 detects the presence of a specific gas within the chamber 100, the chamber 100 may be diagnosed as having a defective seal.

The diagnostic operation (S150) may be performed after a preset time has elapsed from the sealing operation (S140). If the diagnostic operation (S150) is performed immediately after the sealing operation (S140), the sealing may be diagnosed as normal, even if the battery cell 10 is not properly sealed, because it is before the gas within the battery cell 10 leaks into the chamber 100.

The determination unit 600 may further include a diagnostic unit 630 that diagnoses sealing based on the amount of detected gas. While sealing may be determined by an operator, it may also be automatically determined by the diagnostic unit 630 that may determine a poor seal if the pressure of a specific gas is equal to a preset value or more.

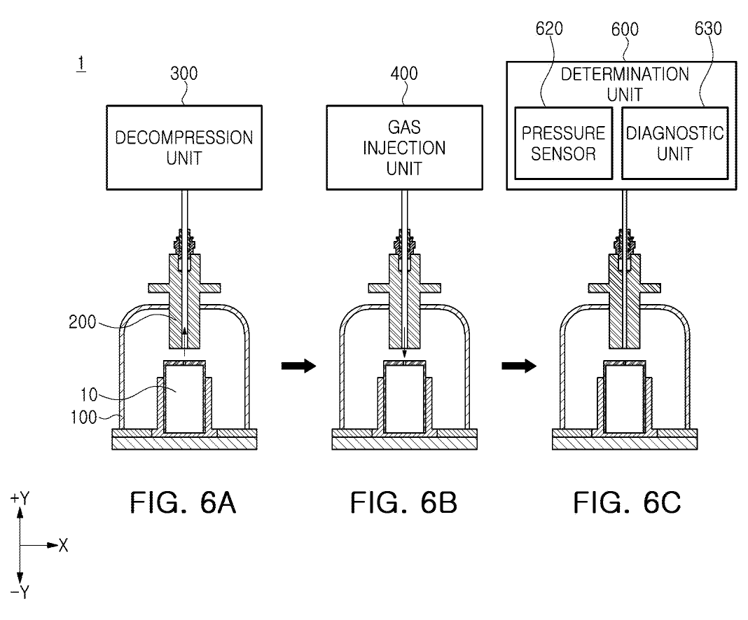

As another example, the determination unit 600 may include a pressure sensor (620 of FIG. 6C) disposed within the chamber 100 and measuring the pressure within the chamber 100, and a diagnostic unit 630 that diagnoses sealing based on the measured pressure.

The pressure sensor 620 measures not only the pressure of a specific gas but also the total gas pressure, making it more economical than equipment that only measures the pressure of a specific gas. If the battery cell 10 is not properly sealed, a specific gas injected into the battery cell 10 may leak into the chamber 100, increasing the overall pressure within the chamber 100 compared to when no leak occurs. For example, if the pressure inside the chamber 100 increases, the sealing condition of the battery cell 10 may be determined as defective. If the pressure inside the chamber 100 remains constant, the sealing condition of the battery cell 10 may be determined as normal. This determination may be performed by an operator, but may also be automatically determined by a diagnostic unit 630, which may determine a defective sealing condition if the measured total pressure is equal to a preset value or more.

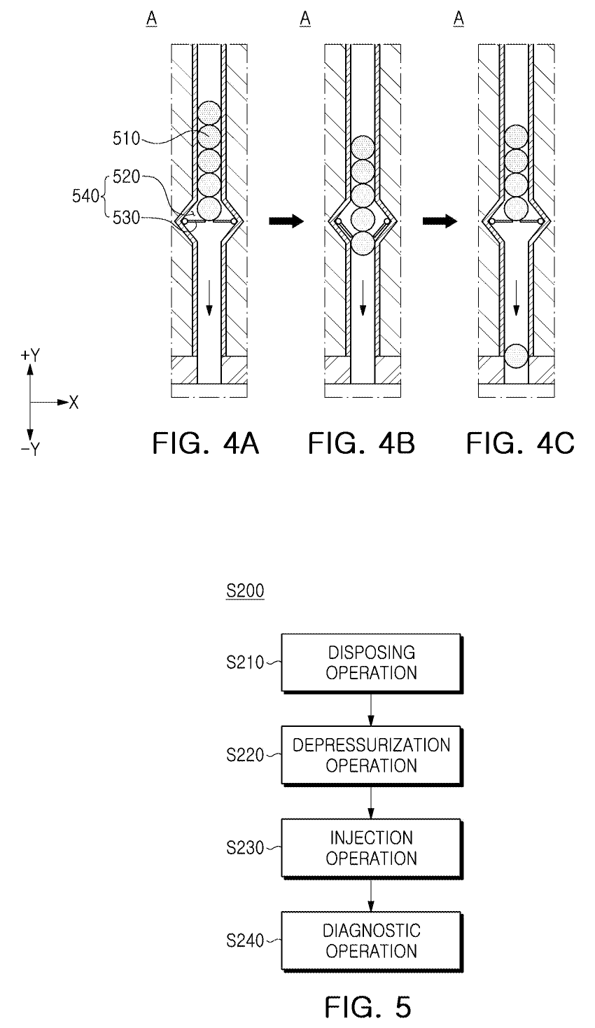

FIGS. 4A, 4B and 4C are cross-sectional views sequentially illustrating the operation of the sealing member installation unit 500 of a seal inspection device 1 for a battery cell according to an embodiment.

The sealing member installation unit 500 may include an adjustment unit 540 that is disposed to enable the sealing members 510 to be installed one by one individually. The adjustment unit 540 may include an opening/closing unit 530 disposed to enable sealing members 510 to be installed one by one, and an adjustment space 520 in which the opening/closing unit 530 is disposed.

For example, the opening/closing unit 530 may have a configuration in which a pair of bars are disposed to be horizontally spaced apart from each other at a predetermined interval. In this case, the predetermined interval may be smaller than the diameter of the ball. The opening/closing unit 530 may have a hinge structure in which both ends of the bars are fixed and each of the pair of bars rotates around a fixed axis.

The opening/closing unit 530 exists in a closed state, and the sealing member 510 may be stacked on the upper side (+Y) of the closed opening/closing unit 530. The closed state may indicate that the opening/closing unit 530 is disposed horizontally.

The opening/closing unit 530 may be opened upon receiving a signal. Once the opening/closing unit 530 is in the open state, one of the stacked sealing members 510 may move toward the lower side (-Y) of the opening/closing unit 530. The open state may refer to a state in which the right bar of the opening/closing unit 530 rotates counterclockwise and the left bar rotates clockwise. As a pair of bars rotate, a predetermined gap between the pair of bars may increase compared to the closed state, thereby causing the sealing member 510 to move toward the lower side (-Y) of the opening/closing unit 530. When the sealing member 510 moves toward the lower side (-Y) of the opening/closing unit 530, the opening/closing unit 530 may be closed again.

FIG. 5 is a flowchart illustrating a method of inspecting the sealing of a battery cell (S200) according to another embodiment. FIGS. 6A, 6B and 6C are cross-sectional views sequentially illustrating the operation of a seal inspection device 1 for a battery cell according to another embodiment.

Compared to FIGS. 2, 3A, 3B, 3C and 3D, the method of inspecting the sealing of a battery cell (S200) illustrated in FIGS. 5, 6A, 6B and 6C differs in a battery cell 10 being inspected. FIGS. 5, 6A, 6B and 6C will be described below focusing on the differences from FIGS. 2, 3A, 3B, 3C and 3D.

The method of inspecting the sealing of a battery cell (S200) according to another embodiment may include a disposing operation (S210) of disposing the battery cell 10 within a chamber 100. At this time, the battery cell 10 may be in a state where the electrolyte has been injected and the inlet (H) has been sealed. For example, the battery cell 10 illustrated in FIGS. 2, 3A and 3B is a semi-finished battery cell 10, while the battery cell 10 illustrated in FIGS. 5, 6A, 6B and 6C may be a finished battery cell 10.

A method of inspecting sealing of a battery cell (S200) according to another embodiment may include a depressurization operation (S220) of depressurizing the interior of the chamber 100. If the battery cell 10 is not properly sealed, the gas within the battery cell 10 may also be released to the outside due to the depressurization within the chamber 100. Therefore, when the interior of the chamber 100 is depressurized for a sufficient period of time, the interior of the battery cell 10 may also be depressurized.

A method of inspecting the sealing of a battery cell (S200) according to another embodiment may include an injection operation (S230) of injecting gas into the chamber 100. The gas injected into the chamber 100 may include an inert gas. The inert gas may include helium, which diffuses easily, which may improve the accuracy and speed of the inspection.

If the battery cell 10 is not properly sealed, the gas injected into the chamber 100 may flow into the battery cell 10. When the gas is injected into the chamber 100, the pressure inside the chamber 100 increases due to the injected gas, and the battery cell 10 may be in a depressurized state. Therefore, if the sealing of the battery cell 10 is incomplete, the gas injected into the chamber 100 may flow into the battery cell 10.

According to another embodiment, a method of inspecting the sealing of a battery cell (S200) may include a diagnostic operation (S240) of diagnosing whether gas injected into the chamber 100 flows into the battery cell 10, performed after the injection operation (S230).

The diagnostic operation (S240) may be performed after a preset time has elapsed from the injection operation (S230) to increase the accuracy of the inspection. Conversely, if the diagnosis is performed immediately after the gas is injected into the chamber 100, the inspection accuracy may be reduced because the gas inside the chamber 100 has not yet flowed into the battery cell 10.

The diagnostic operation (S240) may be performed based on the pressure of the gas inside the chamber 100. If the pressure of the gas inside the chamber 100 decreases after a predetermined amount of gas is injected into the chamber 100 and a preset time has elapsed, the sealing condition may be determined to be defective. Conversely, if a certain amount of gas is injected into the chamber 100 and the pressure of the gas inside the chamber 100 remains constant even after a preset period of time has elapsed, the sealing state may be determined to be normal.

As set forth above, according to an embodiment, the seal inspection equipment and process for battery cells may be simplified.

According to an embodiment, the accuracy of the seal inspection for battery cells may be improved.

Only specific examples of implementations of certain embodiments are described. Variations, improvements and enhancements of the disclosed embodiments and other embodiments may be made based on the disclosure of this patent document.

The above description is merely an example of applying the principles of the present disclosure, and other configurations may be included without departing from the scope of the present disclosure. Furthermore, some components of the above-described embodiments may be omitted, and the embodiments may be combined with each other.

What is claimed is:

1. A seal inspection device for a battery cell, comprising:
a chamber in which a battery cell is disposed;
a hopper disposed to be in close contact with the battery cell;
a decompression unit structured to depressurize an interior of the chamber;
a gas injection unit structured to inject gas into the chamber or an interior of the battery cell;
a sealing member installation unit structured to install a sealing member in an inlet of the battery cell to seal the inlet; and
a determination unit structured to determine whether the battery cell is sealed.

2. The seal inspection device of claim 1, wherein the determination unit includes a gas detection unit detecting gas within the chamber.

3. The seal inspection device of claim 2, wherein the determination unit further includes a diagnostic unit structured to diagnose whether the chamber is sealed, based on an amount of detected gas.

4. The seal inspection device of claim 1, wherein the determination unit includes,
a pressure sensor disposed within the chamber and measuring pressure within the chamber; and
a diagnostic unit structured to diagnose whether the chamber is sealed, based on the measured pressure.

5. The seal inspection device of claim 1, wherein the gas includes an inert gas.

6. The seal inspection device of claim 5, wherein the inert gas includes helium.

7. The seal inspection device of claim 1, wherein the sealing member includes a ball, and
the sealing member installation unit includes an adjustment unit that enables the sealing member to be installed one by one in the inlet.

8. The seal inspection device of claim 7, wherein the adjustment unit includes an opening/closing unit disposed to enable the sealing member to be installed one by one, and an adjustment space in which the opening/closing unit is disposed.

9. A method of inspecting sealing of a battery cell, comprising:
disposing a battery cell within a chamber;
depressurizing an interior of the chamber;
injecting gas into the battery cell disposed within the chamber;
sealing an inlet of the battery cell, after the injecting; and
diagnosing whether the gas injected into the battery cell has leaked outside of the battery cell.

10. The method of claim 9, wherein the diagnosing is performed based on an internal gas pressure of the chamber.

11. The method of claim 9, wherein the diagnosing is performed after a preset time has elapsed in the sealing.

12. The method of claim 9, wherein the gas includes helium.

13. A method of inspecting sealing of a battery cell, comprising:
disposing a battery cell within a chamber;
depressurizing an interior of the chamber;
injecting gas into the chamber; and
diagnosing whether the gas injected into the chamber is introduced into the battery cell, after the injecting.

14. The method of claim 13, wherein in the diagnosing, diagnosing is performed based on an internal gas pressure of the chamber.

15. The method of claim 13, wherein the diagnosing is performed after a preset time has elapsed in the injecting.

16. The method of claim 13, wherein the gas includes helium.
